(19) United States
(12) Patent Application Publication
(10) Pub. No.: US 2015/0111183 A1
(43) Pub. Date: Apr. 23, 2015

(54) INFORMATION PROCESSING APPARATUS AND INFORMATION PROCESSING METHOD

(71) Applicant: TERUMO KABUSHIKI KAISHA, Shibuya-ku (JP)

(72) Inventors: Miyuki KOYAMA, Kawasaki-shi (JP); Toshihide TANAKA, Tama-shi (JP); Tadashi SAMESHIMA, Isehara-shi (JP)

(73) Assignee: TERUMO KABUSHIKI KAISHA, Shibuya-ku (JP)

(21) Appl. No.: 14/583,268

(22) Filed: Dec. 26, 2014

Related U.S. Application Data
(63) Continuation of application No. PCT/JP2013/003496, filed on Jun. 4, 2013.

(30) Foreign Application Priority Data
Jun. 29, 2012 (JP) 2012-147548

(51) Int. Cl. G09B 19/04; G09B 5/00; G10L 25/51

(52) U.S. Cl. CPC G09B 19/04; G10L 25/51; G09B 5/00
USPC 434/185

(57) ABSTRACT

An information processing apparatus is disclosed having a storage unit storing a plurality of training text items each including a word, a word string, or a sentence. The information processing apparatus presents a training text item among the plurality of training text items stored in the storage unit as voice output or character string display and calculates the speaking speed based on a voice signal that is input after presenting the training text item. The information processing apparatus compares the calculated speaking speed with a preset target speaking speed and reports the comparison result.

### CROSS-REFERENCES TO RELATED APPLICATIONS

This application is a continuation of International Application No. PCT/JP2013/003496 filed on Jun. 4, 2013, and claims priority to Japanese Application No. 2012-147548 filed on Jun. 29, 2012, the entire content of both of which is incorporated herein by reference.

### TECHNICAL FIELD

The present disclosure generally relates to an information processing apparatus and an information processing method.

### BACKGROUND DISCUSSION

Speech rehabilitation can be performed, under guidance or supervision of speech therapists, on patients with language deficits such as those suffering from aphasia that occurs because the language area is damaged by a cerebrovascular accident, such as cerebral hemorrhage or cerebral infarction, those suffering from dysarthria that occurs because an organ related to articulation becomes dysfunctional, and those suffering from speech deficits due to Parkinson's disease.

One method for improving the clarity of speech of such patients with speech deficits is to reduce the speaking speed, so training for making patients speak slowly can be an important option for speech rehabilitation.

As an apparatus for measuring the speaking speed of a person, JP-A-2008-262120 proposes a speech evaluation apparatus used for speech exercise for announcers or the like.

However, the speech evaluation apparatus proposed in JP-A-2008-262120 is intended for speech exercise for able-bodied people such as announcers, not for speech rehabilitation for patients with language deficits, so the speech evaluation apparatus is not suitable for the speech training of patients with speech deficits. In general speech training, the speech therapist presents a sentence or word to a patient, the patient reads out the presented sentence or word, and the speech therapist instructs the patient to, for example, speak slower or faster. For example, since the speaking speed is determined based on the feeling of the speech therapist, it can be difficult to evaluate the patient. In addition, the necessity of a speech therapist can reduce the efficiency of the training of a patient with language deficits.

### SUMMARY

In accordance with an exemplary embodiment, an information processing apparatus and information processing method for performing speech training in speech rehabilitation is disclosed.

In accordance with an exemplary embodiment, an information processing apparatus is disclosed, which can include a storage section storing a plurality of training text items including a word, a word string, or a sentence, a presentation section presenting a training text item among the plurality of training text items stored in the storage section, a calculation section calculating a speaking speed based on a voice signal that is input after the training text item is presented by the presentation section, a comparison section making comparison between the speaking speed calculated by the calculation section and a preset target speaking speed, and a reporting section reporting a result of the comparison made by the comparison section.

In accordance with an exemplary embodiment, an information processing method assisting speech training is disclosed, the method comprising: presenting a training text item among a plurality of training text items stored in a storage section, each of the training text items including a word, a word string, or a sentence; calculating a speaking speed based on a voice signal that is input after the training text item is presented in the presenting step; comparing the speaking speed calculated in the calculating step with a preset target speaking speed; and reporting the speaking speed calculated in the calculating step or a comparison result obtained in the comparing step.

In accordance with an exemplary embodiment, a non-transitory computer-readable storage medium stored with a program for an information processing method is disclosed, the program causing the information processing method to execute a process comprising: presenting a training text item among a plurality of training text items stored in a storage section, each of the training text items including a word, a word string, or a sentence; calculating a speaking speed based on a voice signal that is input after the training text item is presented in the presenting step; comparing the speaking speed calculated in the calculating step with a preset target speaking speed; and reporting the speaking speed calculated in the calculating step or a comparison result obtained in the comparing step.

In accordance with an exemplary embodiment, a patient with language deficits can exercise appropriate speech training.

### BRIEF DESCRIPTION OF THE DRAWINGS

The present disclosure will become obvious from the following descriptions with reference to attached drawings. In the attached drawings, the same or similar components are given the same reference characters.

The attached drawings are included in the specification and a part thereof, indicate embodiments of the disclosure, and used together with descriptions thereof to describe the principle of the disclosure.

FIG. 1 shows the appearance structure of an exemplary rehabilitation robot including an information processing apparatus according to an exemplary embodiment of the present disclosure.

FIG. 2 is a block diagram showing an example of the functional structure of the rehabilitation robot.

FIG. 3A shows an example of the data structure of an exemplary text database.

FIG. 3B shows an example of the data structure of an exemplary trainee information table.

FIG. 4 is a flowchart showing an exemplary speech training process.

FIG. 5 shows interactions with a trainee in the speech training process.

FIG. 6A shows display on an exemplary tablet terminal in the speech training process.

FIG. 6B shows display on the tablet terminal in the speech training process.

FIG. 6C shows display on the tablet terminal in the speech training process.

FIG. 6D shows display on the tablet terminal in the speech training process.

FIG. 7A shows the measurement process of an exemplary speaking speed.

FIG. 7B shows the measurement process of the exemplary speaking speed.

FIG. 8A shows an example of the data structure of an exemplary trainee information table.

FIG. 8B shows an example of the data structure of the trainee information table.

FIG. 9 is a flowchart showing the evaluation of the pronunciation of a weak sound.

FIG. 10 is a flowchart showing the automatic collection of weak sounds.

### DETAILED DESCRIPTION

Embodiments of the present disclosure will be described with reference to the drawings. Since the following exemplary embodiments can include exemplary examples of the present disclosure, technically preferable limitations can be imposed on the exemplary examples. However, the scope of the disclosure is not limited to these aspects unless descriptions to limit the disclosure are given in the following description.

1. Appearance Structure of a Rehabilitation Robot

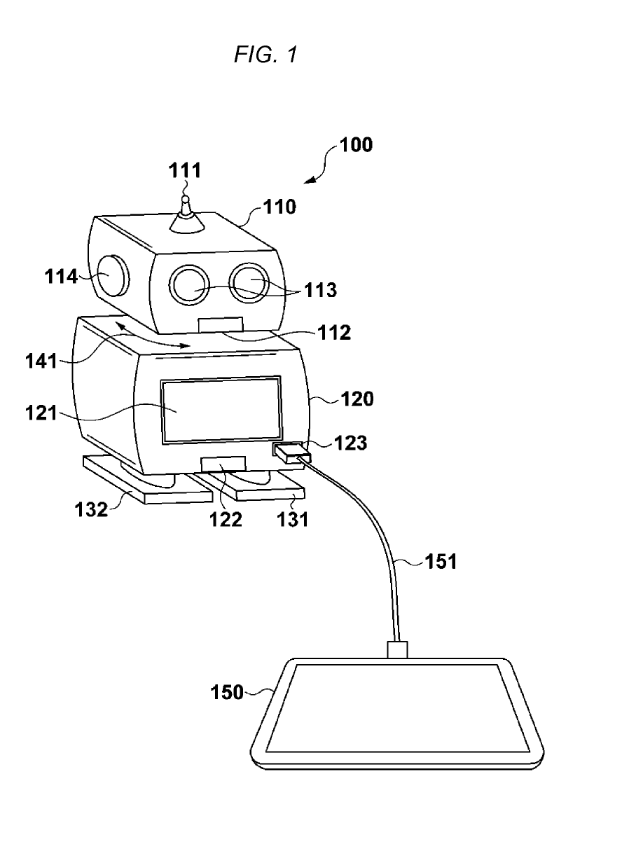

FIG. 1 shows the appearance structure of an exemplary rehabilitation robot 100, which is an information processing apparatus according to the present embodiment. As shown in FIG. 1, the rehabilitation robot 100 for assisting the speech exercise by a trainee such as a patient with language deficits can include a head 110, a body 120, and feet (a left foot 131 and a right foot 132).

The head 110 can include a switch 111 used by the patient to give various instructions to the rehabilitation robot 100, a camera 113 for imaging an external environment and grasping the position and the face orientation of the patient, and a microphone 112 for obtaining patient utterance. In addition, the head 110 can include a lamp 114 illuminating according to an instruction by the switch 111 and a voice or the like input to the microphone 112.

The body 120 can include a touch panel display 121 for displaying data required for the rehabilitation of a patient with language deficits or for inputting an instruction for the patient with language deficits through a touch operation and a speaker 122 for outputting a voice to the trainee. The touch panel display 121 may be built into the rehabilitation robot 100 or may be connected through an external output.

Since the body 120 has the left foot 131 and the right foot 132 connected to the body 120, the entire rehabilitation robot 100 can be moved in any direction. The head 110 is configured to rotate (that is, swing) in the direction of an arrow 141 relative to the body 120. Accordingly, the entire rehabilitation robot 100 or only the head 110 can be turned to the trainee.

In addition, the body 120 has a connector unit 123 to which a cable 151 for connecting an external apparatus such as a tablet terminal 150 can be connected. Since the function achieved by the touch panel display 121 can be similar to that achieved by the tablet terminal 150 in the following embodiments, the touch panel display 121 may be omitted. In addition, connection with an external apparatus may be performed using wireless communication instead of a wired connection via the connector unit 123.

2. Functional Structure of the Rehabilitation Robot

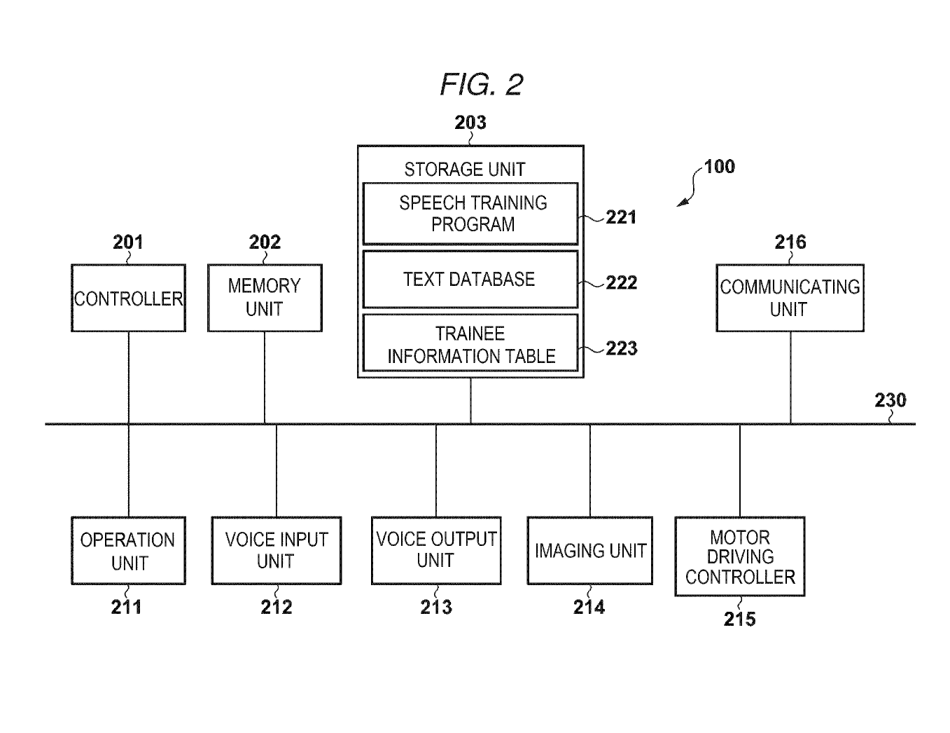

Next, the functional structure of the rehabilitation robot 100 will be described. FIG. 2 shows the functional structure of the rehabilitation robot 100 in accordance with an exemplary embodiment.

As shown in FIG. 2, the rehabilitation robot 100 can include a controller (computer) 201, a memory unit 202, and a storage unit 203, which is an example of a storage section. The storage unit 203 can be configured to store a speech training program 221, a text database 222, and a trainee information table 223. The controller 201 can achieve a speech training process, which will be described later, by executing the speech training program 221. The controller 201 performing the speech training program 221 is an example of a component achieving sections of the disclosure.

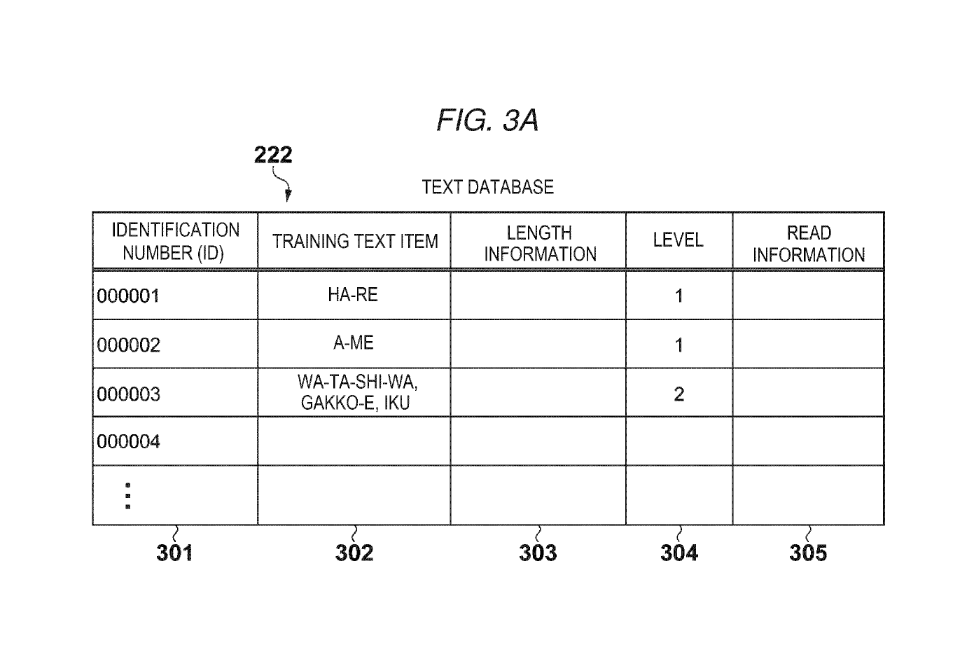

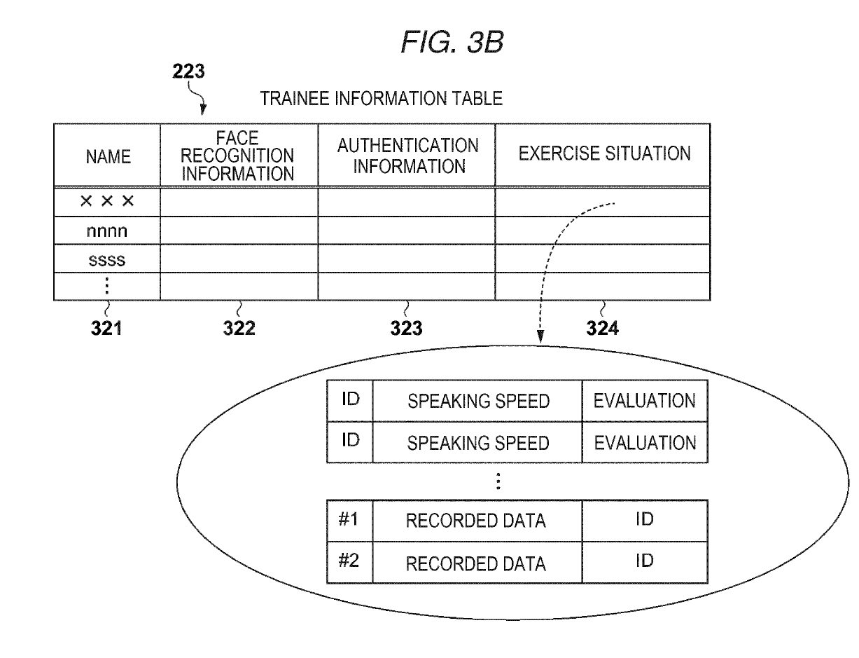

The text database 222 can store words, word strings, and sentences used for speech training. In the following description of this specification, words, word strings, and sentences used for speech training are referred to as training text items. FIG. 3A shows an example of the data structure of the text database 222. As shown in FIG. 3A, each training text item can be assigned an identification number (ID) 301. A training text item 302 registers text data indicating a word or sentence. Length information 303 registers a mora number and/or the number of words owned by a training text item. In Japanese, for example, the number of characters when a training text item is represented according to the katakana notation may be used as the length information. In accordance with an exemplary embodiment, for example, a level 304A can hold a training level determined by the mora number, the number of words, and so on. For example, the higher the mora number or the number of words, the higher the difficulty level (level value) of training becomes. For example, the example can use training levels 1 to 5. Read information 305 is an information used when a training text item is read out by synthesized voice.

The trainee information table 223 registers information about trainees of speech training. FIG. 3B shows an example of the data structure of the trainee information table 223. A name 321 registers the name of a trainee. Face recognition information 322 registers information used by the controller 201 to recognize the face of a trainee. Authentication information 323 is information such as a password used to authenticate a trainee. An exercise situation 324 records the identification number (identification number of a training text item in the text database 222) of the training text item for which the trainee has exercised speech training, the measurement result of the speaking speed for the training text item, the evaluation result, and so on. The exercise situation 324 can also store recording data including a predetermined number of past speeches. In accordance with an exemplary embodiment, the speech therapist can know the exercise situation and the exercise achievement of a trainee with reference to the content recorded in the exercise situation 324.

Although the storage unit 203 stores various programs and data for achieving other functions of the rehabilitation robot 100, their descriptions can be omitted.

In accordance with an exemplary embodiment as shown in FIG. 2, an operation unit 211 receives an operation input from a switch 111 or the touch panel display 121 and provides a signal for the controller 201, and controls the illumination of the lamp 114 and the display of the touch panel display 121 under the control of the controller 201. A voice input unit 212 stores a voice signal input from the microphone 112 in the memory unit 202 as digital data, under the control of the controller 201. A voice output unit 213 drives the speaker 122 and outputs synthesized voice under the control of the controller 201. An imaging unit 214 controls the camera 113 and stores image information obtained by the camera 113 in the memory unit 202, under the control of the controller 201. A motor driving controller 215 controls motors for driving wheels disposed in the left foot 131 and the right foot 132 and controls a motor that is disposed in the head 110 and swings the head 110.

A communicating unit 216 can include the connector unit 123 and connects the controller 201 and the tablet terminal 150 to communicate with each other. Although the tablet terminal 150 and the rehabilitation robot 100 are interconnected via a wired manner in FIG. 1, it will be appreciated that the tablet terminal 150 and the rehabilitation robot 100 may be connected wirelessly. The above components are interconnected via a bus 230. The text database 222 and the trainee information table 223 can be edited by the tablet terminal 150, a personal computer, and the like connected via the communicating unit 216.

3. Flow of a Speech Training Process

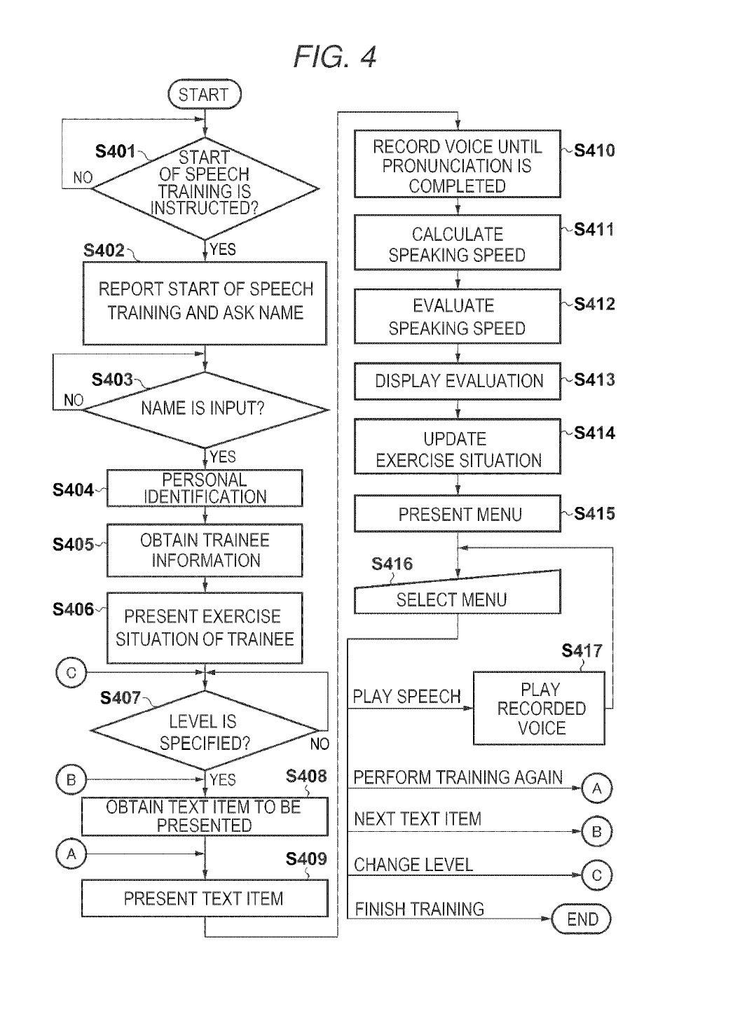

Next, a speech training process in the present embodiment performed when the controller 201 executes the speech training program 221 will be described with reference to the flowchart in FIG. 4. Speech training can be started by detection of a predetermined operation such as a depression of the switch 111 of the rehabilitation robot 100, a touch operation on the touch panel display 121, or an operation by the tablet terminal 150 (step S401). Since the user interface achieved by the touch panel display 121 is similar to that of the tablet terminal 150, the tablet terminal 150 is used in the following example. However, the user interface for the touch panel display 121 is provided by the controller 201, while the user interface for the tablet terminal 150 is achieved in cooperation between the CPU owned by the tablet terminal 150 and the controller 201. In addition, instead of an intelligent terminal such as the tablet terminal 150, a simple touch panel display may be connected. When such an external touch panel display is connected, the controller 201 can perform the entire control as in the touch panel display 121.

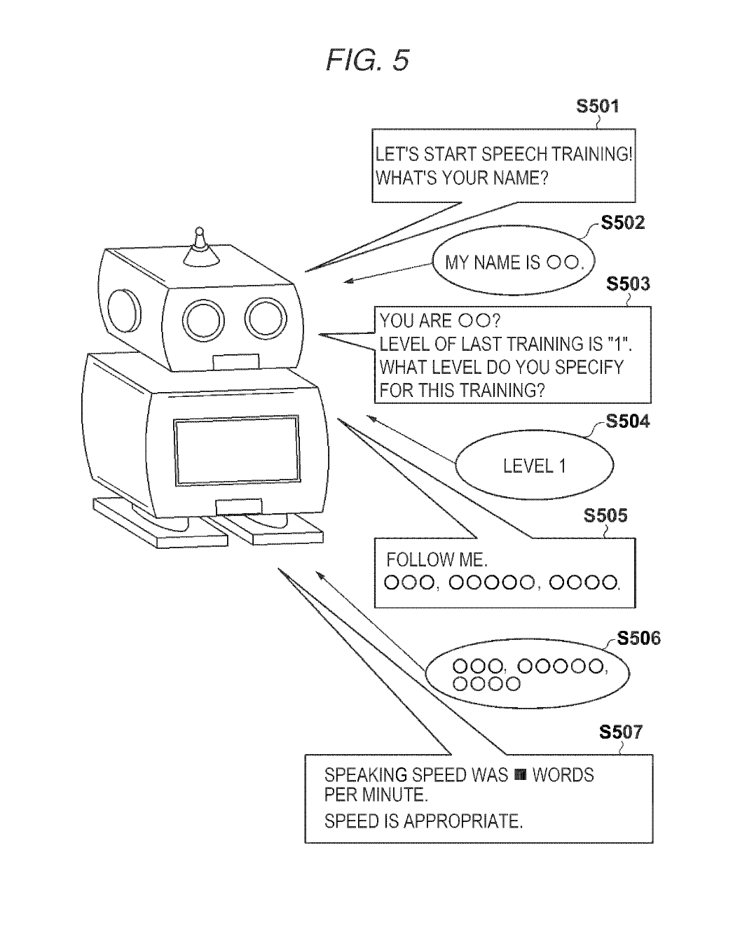

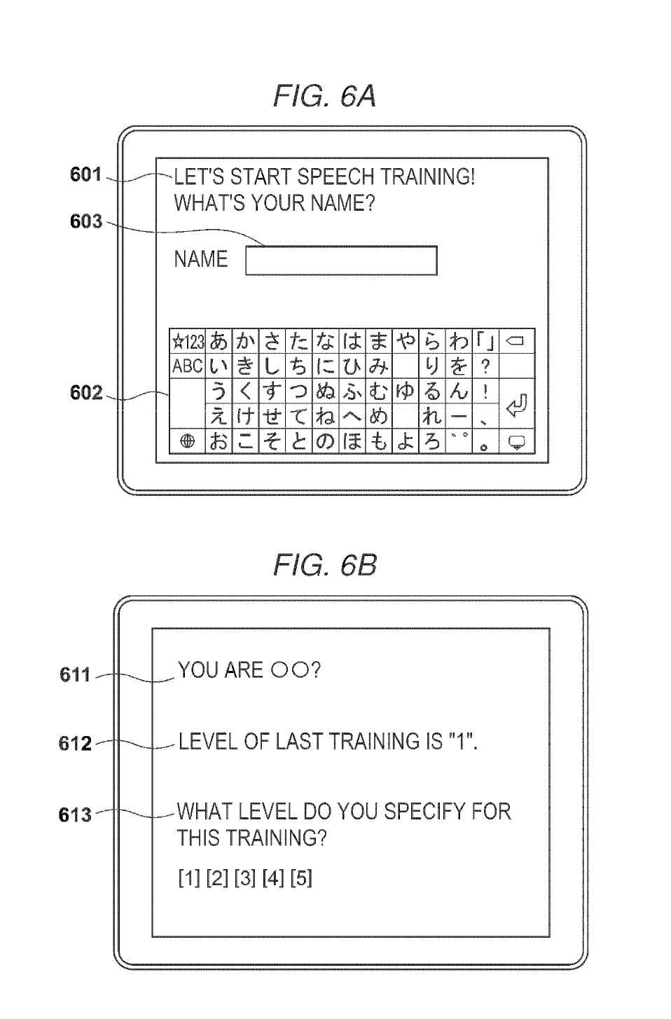

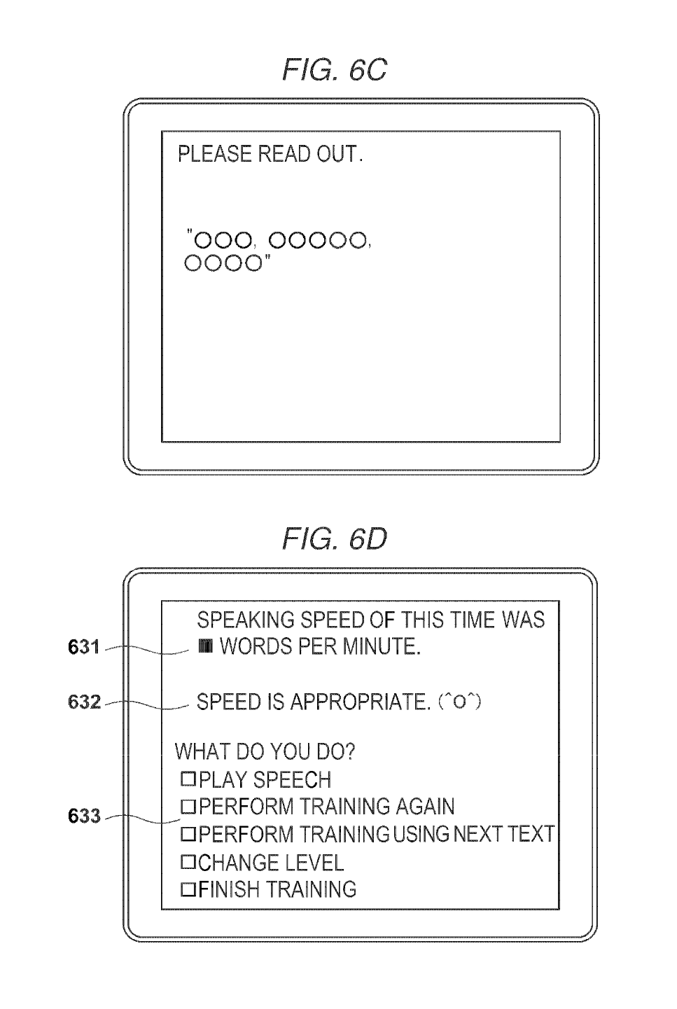

When speech training is started, the controller 201 notifies the trainee or speech therapist of the start of speaking speed training in step S402 and can ask for the name of the trainee. For example, as shown in step S501 in FIG. 5, the controller 201 performs a synthesized voice output via the voice output unit 213. Alternatively, as shown in FIG. 6A, the tablet terminal 150 displays a speech training notification 601 and provides an interface (for example, a Japanese software keyboard 602 and a text box 603) for inputting the name. Then, in step S403, the controller 201 waits for the name to be input by voice via the microphone 112 or the name to be input from the tablet terminal 150.

Once the name of the trainee is input by voice (S502) or the name of the trainee is input from the tablet terminal 150, the controller 201 verifies the personal identification of the trainee using the input name in step S404. In the present exemplary embodiment, such personal identification can be achieved by, for example, a face recognition process using the face recognition information 322 in the trainee information table 223 and the image taken by the camera 113. Personal identification may also be verified by accepting a password from the tablet terminal 150 and comparing the password with the authentication information 323 or authentication may be performed using other types of biometric information, for example, a venous and/or a fingerprint.

After verifying personal identification, the controller 201 obtains the trainee information (such as the name and exercise situation) from the trainee information table 223 in step S405. Then, in step S406, the controller 201 presents the name and exercise situation of the trainee and reports the training level. For example, as shown in step S503 in FIG. 5, the controller 201 reads out the name of the trainee and the level applied in the last training and asks the level to be applied in this training, using voice. Alternatively, as shown in FIG. 6B, the tablet terminal 150 can ask the name (display 611) of the trainee, the level (display 612) of the last training, and the level (display 613) to be applied in this training. As the last training level, the highest level among the training text items registered as exercised in the exercise situation 324 may be presented. When personal identification fails, the controller 201 can report a mismatch between the name and the trainee, and the processing returns to step S401.

When the training level is input by voice as shown in step S504 or the training level is specified via the user interface as shown in FIG. 6B provided by the tablet terminal 150, the processing proceeds to step S408 from step S407. The inputting of the training level via the user interface may be presented on the touch panel display 121 as well as on the tablet terminal 150 as an operation performed by the speech therapist. The controller 201 performing step S408 is an example of a presentation section presenting one of a plurality of text items stored in the storage unit 203 (the text database 222). For example, in step S408, the controller 201 obtains a training text item with a specified level from the text database 222. At this time, the controller 201 may also select a training text item with reference to the exercise situation 324. For example, the controller 201 may not select a training text item for which speech training has been exercised or may select a training text item with a low evaluation value.

In step S409, the controller 201 presents the training text item obtained in step S408 to the trainee. The training text item may be presented by outputting it by voice or displaying it on the tablet terminal 150 as text. For example, in the case of voice output, the training text item is read out by synthesized voice using the read information 305 and then output from the speaker 122 (step S505 in FIG. 5). In the case of display as character strings, the training text item can be displayed on the tablet terminal 150 as shown in FIG. 6C.

In displaying the training text item, the trainee may be assisted to grasp the pace of speech. For example, a tapping sound is made for each segment when the training text item is read out by synthesized voice, and the tapping sound continues to be output after the training text item is read out. The trainee can speak while listening to the tapping sound to help grasp the pace of speech. In addition, in displaying the training text item on the tablet terminal 150, the display format of characters may be changed sequentially from the beginning at a target speaking speed. The trainee can speak at the target speaking speed by reading out the training text item to help follow the display format.

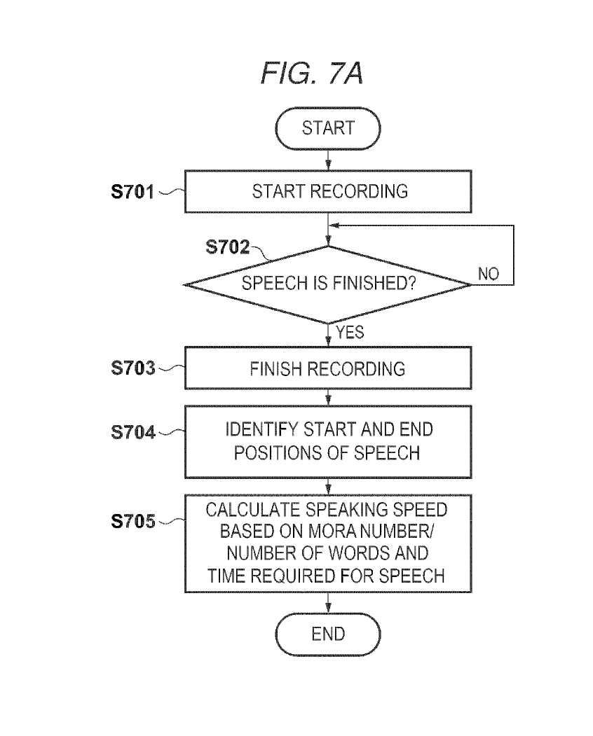

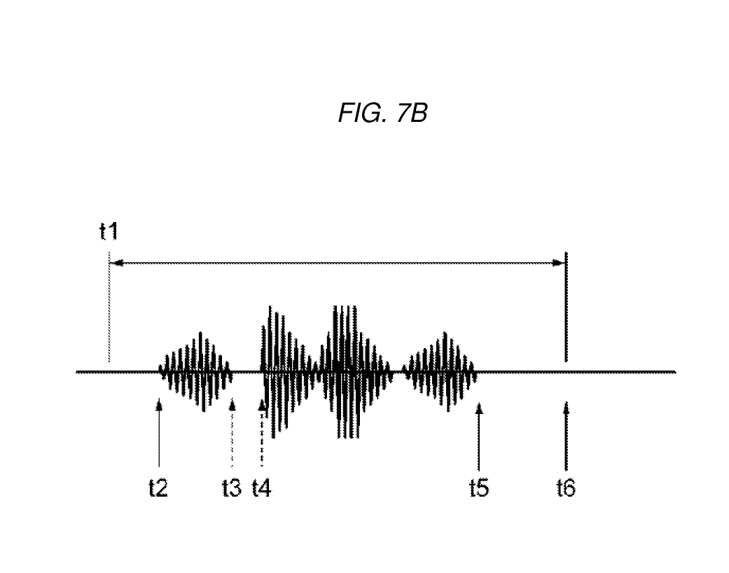

After presenting the training text item, the controller 201 starts recording with the microphone 112 in step S410 to record the speech (step S506 in FIG. 5) of the trainee. The recorded data is held in the memory unit 202. The controller 201 performing step S411 is an example of a calculation section calculating the speaking speed based on a voice signal input after the text item is presented. For example, in step S411, the controller 201 can calculate the speaking speed by analyzing the recorded data. The recording of speech and the calculation of the speaking speed in steps S410 and S411 will be described below with reference to the flowchart in FIG. 7A and an example of the voice input signal in FIG. 7B.

When the training text item is presented in step S409, the controller 201 starts storing (recording) the voice signal input from the microphone 112 in the memory unit 202 in step S701 by controlling the voice input unit 212 (time t1 in FIG. 7B). Until speech is determined to be completed in step S702, the controller 201 continues the recording started in step S701. In the present embodiment, when a voiceless period continues for a predetermined period of time (for example, 2 seconds) or more, speech is determined to be completed. For example, in the case of the example shown in FIG. 7B, there is a voiceless period between time t3 and time t4. However, since the duration is shorter than the predetermined period of time, speech is not determined to be completed. In contrast, for example, since a voiceless state continues after time t5 for the predetermined period of time, speech is determined to be completed at time t6.

When speech is determined to be completed, the processing proceeds to step S703 from step S702. In step S703, the controller 201 finishes recording. Accordingly, when the voice signal is input as shown in FIG. 7B, recording is performed in the period from time t1 to time t6.

In step S704, the controller 201 identifies the start position and the end position of speech by analyzing the voice signal recorded in steps S701 to S703. In the present embodiment, for example, the position at which a voice signal is first detected can be the start position of speech and the start position of a voiceless period that continues for a predetermined period of time is the end position of speech. For example, in the example in FIG. 7B, time t2 is identified as the start position (start time) of speech and time t5 is identified as the end position (end time) of speech. In step S705, the controller 201 calculates the speaking speed based on the time (difference between start time t2 and end time t5) required for speech and the mora number/the number of words of the training text item exercised. Accordingly, the speaking speed is represented as, for example, N words per minute or N mora per second. For example, in the case of Japanese, the number of characters per second when the training text item is represented according to the katakana notation may be used as the speaking speed.

Upon calculating the speaking speed as described above, the processing proceeds to step S412. The controller 201 performing steps S412 and S413 is an example of a comparison section comparing the calculated speaking speed with a preset target speaking speed and a reporting section reporting the comparison result. For example, the controller 201 can evaluate this speech by comparing the speaking speed calculated in step S411 with the target speaking speed and, in step S413, presents the evaluation corresponding to the comparison result. In accordance with an exemplary embodiment, the evaluation may be presented by voice via the voice output unit 213 and the speaker 122 as shown in step S507 or by display on the tablet terminal 150 as shown by reference numeral 631 in FIG. 6D.

The evaluation displayed as an evaluation statement 632 or reported by voice (S507) is shown below when, for example, the measured speaking speed is “N words per minute” and the target speaking speed is “R words per minute”. However, it will be appreciated that the following evaluation is only an example and the evaluation is not limited to this example.
   |N−R|≦5: “Speed is appropriate.”
5<N−R≦15: “Speed is a little high.”
N−R>15: “Speed is too high. Speak more slowly.”
N−R<−5: “Speak faster.”

In step S414, the controller 201 associates the recording data (step S410), the speaking speed (step S411), and the evaluation result (step S412) obtained as described above with the ID of the exercised training text item and records them as the exercise situation 324. In this way, the corresponding exercise situations 324 in the trainee information table 223 are updated. In recording of the recording data, the recording data only in the time period (the time period in which speech is actually recorded) from time t2 to time t5 in FIG. 7B may be extracted and recorded.

Subsequently, in step S415, the controller 201 presents a menu 633 (FIG. 6D) using the tablet terminal 150. For example, the following items are displayed in the menu 633. The menu 633 may be displayed on the touch panel display 121 as an operation performed by the speech therapist.
[PLAY SPEECH]: Plays the recorded speech using the speaker 122.
[AGAIN]: Performs speech exercise again using the previous training text item.
[NEXT TEXT]: Performs speech exercise using a new training text item.
[CHANGE LEVEL]: Changes the level and performs speech exercise using a new training text item.
[FINISH TRAINING]: Finishes the speech training.

When [PLAY SPEECH] is selected in step S416, the processing proceeds to step S417 and the recorded speech is played. The exercise situation 324 records a predetermined number of past speeches and the trainee can select and play a desired speech. For example, FIG. 3B shows two pieces (#1 and #2) of past recording data. For example, in this case, when [PLAY SPEECH] is selected, the controller 201 causes the user to specify the recording data (last, last but one, etc.) to be played. This specification may be received by voice or an operation input from the tablet terminal 150.

When [AGAIN] is selected in step S416, the processing proceeds to step S409, the controller 201 presents the training text item currently selected, and the above processing is repeated. When [NEXT TEXT] is selected in step S416, the processing proceeds to step S408, the controller 201 obtains, from the text database 222, a new training text item with the level currently selected, and performs the processing in step S409 and later using the new training text item.

When [CHANGE LEVEL] is selected in step S416, the processing proceeds to step S407, performs the voice output shown in the step S503 in FIG. 5 or the display shown in FIG. 6B, and waits for a new training level to be input. When a new training level is input, the processing in step S408 and later is performed. When [FINISH TRAINING] is selected in step S416, the processing ends.

As described above, according to the present embodiment, the trainee can perform speech exercise while interacting with the rehabilitation robot 100. In addition, since the speaking speed and evaluation result are reported each time the trainee speaks, the trainee can perform exercise while checking the performance of speech.

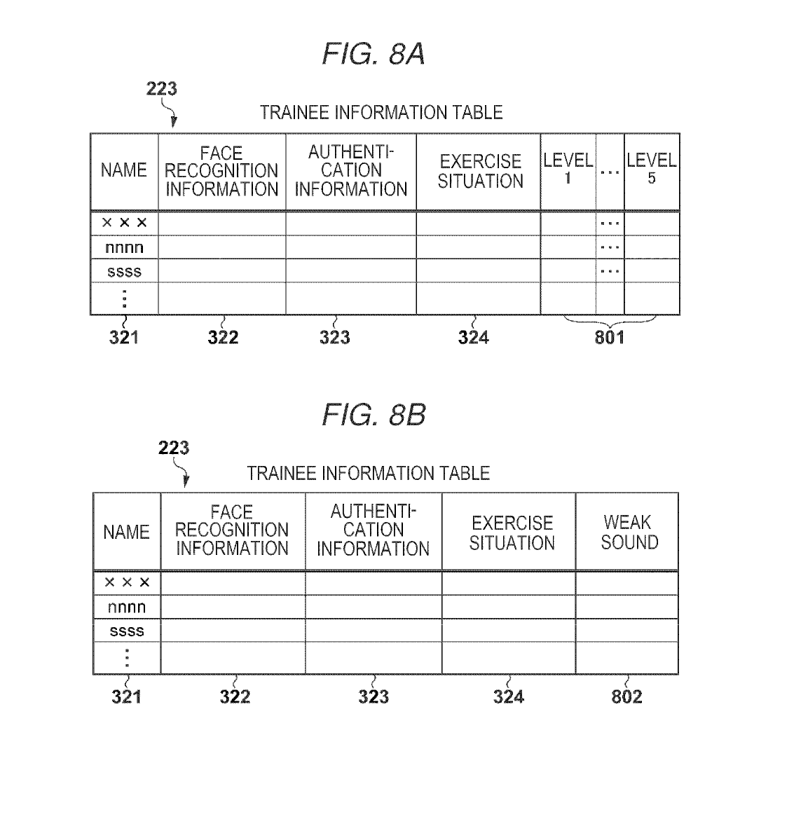

Although the training text item to be obtained is selected from the text database 222 depending on the specified level (regardless of the trainee) in the above embodiment, the disclosure is not limited to this embodiment. For example, the speech therapist may specify a training text item with any level depending on the situation of the trainee. For example, the speech therapist may select a training text used by the trainee from the text database 222 using an external apparatus connected to the rehabilitation robot 100 and registers the training text item in the trainee information table 223. For example, as shown in FIG. 8A, the trainee information table 223 is provided with level fields 801 each including the ID of a training text item used for each level, for each trainee. The speech therapist can register a desired training text item in the text database 222 in a desired level using the external apparatus. For example, in this way, training text items corresponding to each level in the trainee information table 223 are registered using their IDs. In step S408, the controller 201 selects the training text item to be presented by selecting one of registered IDs with the level specified in step S407 with reference to the level field 801 of the trainee information table 223.

As described above, in the exemplary embodiment disclosed above, the rehabilitation robot 100 presents a text item appropriate for speech training and evaluates the speech state of the trainee, so speech training can be performed correctly only by the trainee.

Dysarthric patients with language deficits may have difficulties in pronouncing specific sounds such as “TA” and “KA-row (consonants beginning with k)” in the Japanese syllabary. In accordance with an exemplary second embodiment considers the inclusion of such sounds (referred to below as weak sounds) difficult for the trainee to pronounce when selecting a training text item. Intentional selection of a training text item including a weak sound for speech training achieves speech training for improving the speaking speed and overcoming the weak sound. The structure of the information processing apparatus according to the second exemplary embodiment is similar to that of the first exemplary embodiment.

FIG. 8 shows the trainee information table 223 in which a weak sound 802 can be registered, as an example of a registration section for registering weak sounds difficult for the trainee to pronounce. The speech therapist can identify the sounds difficult for the trainee to pronounce and registers the results in the weak sound 802 of the trainee information table 223 shown in FIG. 8B. Since the sounds difficult to pronounce depend on the trainee, the field of the weak sound 802 can be provided for each trainee.

The speech training process according to the second exemplary embodiment is substantially the same as in the first embodiment except that, in the second embodiment, a weak sound is used as one of selection conditions when a training text item is selected. For example, when the controller 201 selects a training text item with a specified level from the text database 222 in step S407 in FIG. 4, the controller 201 searches for a training text item with a weak sound. Accordingly, the training text item used for speech training includes a weak sound difficult for the trainee to pronounce, so the trainee can exercise speech training for the weak sound at the same time.

The method for selecting a training text item is not limited to the above. For example, a training text item including a weak sound may not necessarily be selected for each training and the training text may be selected only once per a predetermined number of times. Alternatively, the number of weak sounds included in one training text item may be used as a selection condition by associating the number with the training level. For example, control may be performed so that a training text item including one weak sound is selected for training level 1 and a training text item including two weak sounds is selected for training level 2. Alternatively, when the number of weak sounds included in a training text item is equal to or more than a predetermined number, the training text item may be assumed to have a level one higher than the level set in the text database 222.

As described above, since a training text item including a sound difficult for a patient with language deficits to pronounce is actively selected in speech training according to the second embodiment, training for speaking speed and training for pronouncing a weak sound can be performed concurrently. In addition, by comparing the speaking speed between a training text item including a weak sound and a training text item not including the weak sound, the effect or the like of the weak sound on the speaking speed can be determined, thereby providing auxiliary information for the speech therapist to create a rehabilitation plan.

The first exemplary embodiment describes the structure in which the trainee speaks a selected training text item and the speaking speed is calculated based on the speaking time to make evaluation. The second exemplary embodiment describes the structure in which a training text item is selected by specifying the presence or absence of a weak sound of the trainee as a selection condition. The third embodiment will describe the structure in which training for pronouncing a weak sound correctly is taken into consideration.

In accordance with an exemplary embodiment, the waveforms of one sound at the beginning and one sound at the end of a voice signal can be easily clipped and voice recognition can be performed at high precision. For example, when “a-me-ga-fu-ru” in Japanese (“It rains” in English) is input by voice, it is possible to determine whether the sound “a” at the beginning and the sound “ru” at the end are pronounced correctly at high precision. In the speech training process in the third embodiment, training for weak sounds is provided using such features of voice recognition technology.

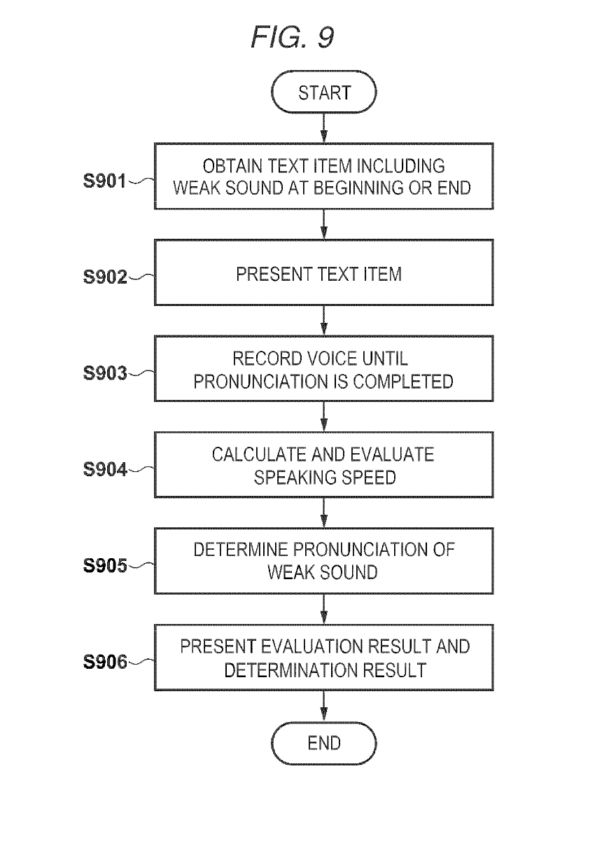

FIG. 9 is a flowchart showing a speech training process according to the third embodiment, which replaces steps S408 to S413 of the speech training process (FIG. 4) in the first embodiment. In step S901, the controller 201 obtains a weak sound of the trainee from the trainee information table 223 and obtains a training text item including the weak sound at the beginning or the end from the text database 222. In step S902, the controller 201 presents the training text item obtained in step S901 by voice output or character display. The text item is presented as shown in step S409.

After presenting the training text item in step S902, the controller 201 starts recording the speech of the trainee in step S903. The recorded data is held in the memory unit 202. Then, in step S904, the controller 201 calculates the speaking speed by analyzing the recorded data and evaluates the speech by comparing the calculated speaking speed with a predetermined target speaking speed. The above processing from step S902 to step S904 is similar to that from step S410 to step S412.

The controller 201 performing step S905 is an example of a determination section determining whether the sound at the beginning of a presented text item matches the sound at the beginning of speech in a voice signal or the sound at the end of the text item matches the sound at the end of speech in the voice signal. For example, in step S905, the controller 201 determines whether the one sound at the beginning or the one sound of the end of the training text item presented in step S902 is spoken correctly. Since a determination is made whether the weak sound is pronounced correctly, the following determination can be made.

When the training text item including the weak sound at the beginning of the presented text item is presented in steps S901 and S902, a determination is made as to whether the one sound at the beginning is pronounced correctly.

When the training text item including the weak sound at the end of the presented text is presented in steps S901 and S902, a determination is made as to whether the one sound at the end is pronounced correctly.

When the training text item including the weak sound at the beginning and the end of the presented text is presented in steps S901 and S902, a determination is made as to whether each of the sounds at the beginning and the end is pronounced correctly.

In step S906, the evaluation result in step S904 and the determination result in step S905 are presented. The evaluation result in step S904 is presented as described in the first exemplary embodiment. In the presentation of the determination result in step S905, the trainee is notified of whether the weak sound has been determined correctly. For example, whether the weak sound is pronounced correctly can be determined by, for example, matching between the waveform of a voice signal recorded in step S903 and the reference waveform. Accordingly, the degree of matching may be classified into a plurality of levels and the determination result may be presented depending on the level to which the degree of matching obtained by matching belongs. For example, the degree of matching is classified into three levels in the descending order of the degree and the messages as shown below are displayed depending on the level.
Level 3: Weak sound “◯” has been pronounced almost correctly.
Level 2: Weak sound “◯” has been pronounced at barely audible levels.
Level 1: Please practice the pronunciation of weak sound “◯”.

As described above, in the third exemplary embodiment, speech training can be performed using a training text item including a weak sound at the beginning or the end and whether the weak sound has been correctly pronounced is reported. Accordingly, the trainee can exercise training while grasping the effects of the training for the weak sound.

In the above third exemplary embodiment, training for weak sounds is exercised together with training for speaking speed, but only training for weak sounds may be performed. In the above embodiment, a training text item including a weak sound at the beginning, the end, or both the beginning and the end is selected. However, training may be performed by separating between training text items including a weak sound at the beginning, the end, and both the beginning and the end. This can detect a symptom in which a training text item including a weak sound at the beginning cannot be pronounced well, but a training text item including a weak sound at the end can be pronounced.

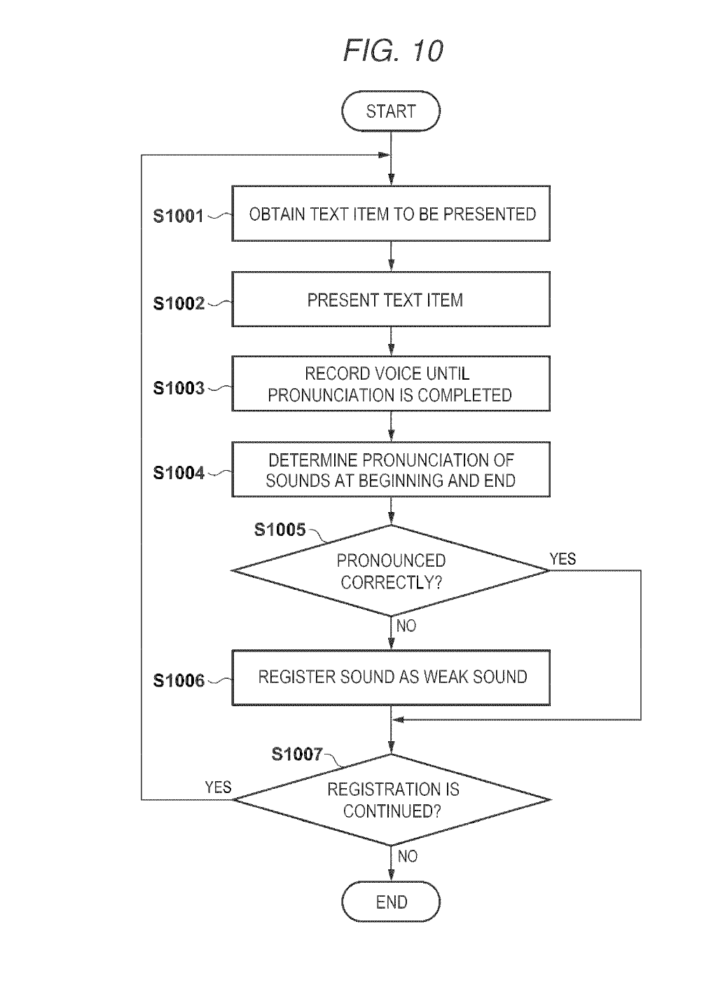

A fourth exemplary embodiment describes another example of the registration section. The weak sounds of the trainee are registered by the speech therapist in the second and third embodiments, but the weak sounds are registered automatically in the fourth exemplary embodiment. FIG. 10 shows a weak sound registration process according to the fourth embodiment.

In step S1001, the controller 201 obtains a training text item from the text database 222. In step S1002, the controller 201 presents the obtained training text item to the trainee and, in step S1003, records the speech. Such processing is similar to that from steps S409 to S412 in the first embodiment (FIG. 4).

In step S1004, the controller 201 determines whether one sound at the beginning and one sound at the end of the voice signal of the recorded speech match the sounds that should be pronounced at the beginning and the end of the presented training text item. This matching process is similar to that described in the third embodiment (step S905). As a result of the determination, when the sound is determined to be pronounced correctly, the processing proceeds to step S1007. When the sound is determined to be pronounced incorrectly, the processing proceeds to step S1006 and the controller 201 registers the sound determined to be pronounced incorrectly in the trainee information table 223 as a weak sound. In step S1007, the processing returns to step S1001 to continue the registration process until an end instruction is received.

In the registration process in the fourth embodiment, weak sounds of the trainee are registered automatically, assisting the speech therapist more strongly.

In step S1006, the sound pronounced at a predetermined level or lower a predetermined number of times may be registered without the sound determined to be pronounced incorrectly being registered immediately. For example, the word determined to be level 1 a number of times more than a predetermined number of times in the level determination described in the fourth embodiment may be registered. For example, in this case, a weak sound can be obtained more efficiently if the training text item to be obtained in step S1001 does not include the sound determined to be pronounced correctly in step S1005 at the beginning or the end and includes the sound determined to be pronounced incorrectly in step S1005 at the beginning or the end.

Although the text database 222 and the trainee information table 223 are included in the information processing apparatus in the above embodiments, the disclosure is not limited to the embodiments. For example, it is appreciated that the text database 222 and the trainee information table 223 may be stored in an external server and required information may be obtained via wireless communication, wired communication, the Internet, or the like.

The disclosure is not limited to the above embodiments and various changes and modifications can be made without departing from the spirit and scope of the disclosure. Accordingly, the following claims are appended to publicize the scope of the disclosure.

The detailed description above describes an information processing apparatus and information processing method. The disclosure is not limited, however, to the precise embodiments and variations described. Various changes, modifications and equivalents can effected by one skilled in the art without departing from the spirit and scope of the disclosure as defined in the accompanying claims. It is expressly intended that all such changes, modifications and equivalents which fall within the scope of the claims are embraced by the claims.

What is claimed is:

1. An information processing apparatus comprising:
a storage section storing a plurality of training text items including a word, a word string, or a sentence;
a presentation section presenting a training text item among the plurality of training text items stored in the storage section;
a calculation section calculating a speaking speed based on a voice signal that is input after the training text item is presented by the presentation section;
a comparison section making comparison between the speaking speed calculated by the calculation section and a preset target speaking speed; and
a reporting section reporting a result of the comparison made by the comparison section.

2. The information processing apparatus according to claim 1,
wherein the presentation section presents the training text item as voice output or character string display.

3. The information processing apparatus according to claim 1,
wherein the calculation section detects a start and an end of speech based on the voice signal and calculates a speaking speed based on a time period from the start to the end of the speech and a length of the training text item presented by the presentation section.

4. The information processing apparatus according to claim 1, comprising:
a registration section registering a weak sound difficult for a trainee to pronounce
wherein the presentation section uses whether the training text item includes the weak sound, as a condition for selecting a training text item from the plurality of training text items.

5. The information processing apparatus according to claim 1, comprising:
a registration section registering a weak sound difficult for a trainee to pronounce; and
a determination section making determination as to whether a sound at a beginning of the presented training text item matches a sound at the beginning of speech in the voice signal or whether a sound at an end of the presented training text item matches a sound at the end of the speech in the voice signal,
wherein the presentation section selects a training text item including the weak sound at the beginning or the end from the plurality of training text items and presents the selected training text item.

6. The information processing apparatus according to claim 4,
wherein the registration section makes a determination as to whether the sound at the beginning of the presented training text item matches the sound at the beginning of speech in the voice signal or whether the sound at the end of the presented training text item matches the sound at the end of the speech in the voice signal, identifies a sound difficult for the trainee to pronounce based on the determination, and registers the identified sound as a weak sound of the trainee.

7. An information processing method assisting speech training, the method comprising:
presenting a training text item among a plurality of training text items stored in a storage section, each of the training text items including a word, a word string, or a sentence;
calculating a speaking speed based on a voice signal that is input after the training text item is presented in the presenting step;
comparing the speaking speed calculated in the calculating step with a preset target speaking speed; and
reporting the speaking speed calculated in the calculating step or a comparison result obtained in the comparing step.

8. A non-transitory computer-readable storage medium stored with a program for an information processing method, the program causing the information processing method to execute a process comprising:
presenting a training text item among a plurality of training text items stored in a storage section, each of the training text items including a word, a word string, or a sentence;
calculating a speaking speed based on a voice signal that is input after the training text item is presented in the presenting step;
comparing the speaking speed calculated in the calculating step with a preset target speaking speed; and
reporting the speaking speed calculated in the calculating step or a comparison result obtained in the comparing step.
